(19) United States
(12) Patent Application Publication
(10) Pub. No.: US 2003/0203266 A1
(43) Pub. Date: Oct. 30, 2003

(54) Polymer electrolyte membrane fuel cell separator plate composition

(76) Inventors: Jeremy Chervinko, Elk Grove, IL (US); Qinbai Fan, Chicago, IL (US); Michael Onischak, St. Charles, IL (US); Leonard G. Marianowski, Mt. Prospect, IL (US)

Correspondence Address: Mark E. Fejer, Gas Technology Institute, 1700 South Mount Prospect Road, Des Plaines, IL, 60018, US

(21) Appl. No.: 10/136,772

(22) Filed: Apr. 30, 2002

(51) Int. Cl. H01M 8/10; H01M 8/24

(52) U.S. Cl. 429/34; 429/32

(57) ABSTRACT

A bipolar separator plate suitable for use in polymer electrolyte membrane fuel cell stacks, which plate is made a composition having in a range of 1 to 4 different graphite components and at least one resin, wherein at least one of the graphite components has graphite particles having a mean diameter in a range of about 10 microns to about 50 microns.

### BACKGROUND OF THE INVENTION

This invention relates to bipolar separator plates suitable for use in polymer electrolyte membrane (PEM) fuel cell stacks and to compositions of materials suitable for use therein. The bipolar separator plate compositions of this invention are lower in cost than conventional compositions, easier and faster to blend and mold into separator plates, and result in separator plates having improved qualities when compared to conventional separator plates.

In a fuel cell stack comprising a plurality of individual fuel cell units, each of which comprises an anode electrode, a cathode electrode and an electrolyte disposed between the anode electrode and the cathode electrode, a bipolar plate, or bipolar separator plate, is disposed in the fuel cell stack between the anode electrode of one fuel cell unit and the cathode electrode of an adjacent fuel cell unit and provides for distribution of the reactant gases to the anode electrode and the cathode electrode. In a polymer electrolyte membrane fuel cell, the electrolyte is a thin ion-conducting membrane such as NAFION®, a perflourinated sulfonic acid polymer available from E. I. DuPont DeNemours & Co. Typically, the bipolar separator plate comprises a centrally disposed active region having a plurality of channels or other structural features for distributing the reactant gases across the surfaces of the electrodes. The bipolar separator plates are frequently made of a mixture of electrically conducting carbon/graphite particles which have been compression molded into the desired shape. Typically, graphite composite bipolar separator plates are produced by heated compression or injection molding. In heated compression molding, the powder mixture is held under pressure at an elevated temperature for at least 30 seconds. For injection molding, the holding time decreases to about 15 seconds, but a high amount of resin is required to make the composite flow. Bipolar separator plates suitable for use in PEM fuel cells are taught, for example, by U.S. Pat. No. 5,942,347, which is incorporated herein by reference in its entirety.

In addition to electrically conducting carbon/graphite particles, suitable bipolar separator plates comprise other additives including a binding or bonding agent, such as an organic resin that causes the carbon/graphite particles to adhere to each other upon reaching the molding temperature, at which temperature the resin melts or cures to form a liquid or solid phase that becomes the binding or bonding agent.

Functional and efficient bipolar separator plate compositions must provide high conductivity and strength with low corrosion and creep rates. These compositions should be low cost, easily blended, quickly moldable and result in finished parts of close dimensional tolerances with a minimal number of operations following the molding operation.

### SUMMARY OF THE INVENTION

Accordingly, it is one object of this invention to provide an improved composition for bipolar separator plates employed in polymer electrolyte membrane fuel cell stacks.

It is one object of this invention to provide a composition for producing bipolar separator plates for polymer electrolyte membrane fuel cell stacks in which blending of the composition prior to formation into the separator plates can be carried out in a simplified manner, one step in the case of batch operated processes as compared to known compositions that require multiple blending steps.

It is a further object of this invention to provide a composition for producing bipolar separator plates for polymer electrolyte membrane fuel cell stacks which provides end-products having close dimensional tolerances.

It is yet a further object of this invention to provide a composition for producing bipolar separator plates for polymer electrolyte membrane fuel cell stacks which is faster and more flexible in molding than known compositions.

These and other objects of this invention are addressed by a fuel cell stack comprising at least one bipolar separator plate comprising a composition comprising in a range of 1 to 4 different graphite components and at least one resin, wherein at least one of the graphite components comprises graphite particles having a mean diameter in a range of about 10 microns to about 50 microns. In accordance with a particularly preferred embodiment only one graphite component is employed in the composition, thereby reducing the cost compared to compositions employing several graphite components. The compositions in accordance with this invention require relatively low maximum molding pressures, typically less than about 3000 psi, to produce the bipolar separator plate. This, in turn, translates into lower capital costs for molding equipment per separator plate produced. The compositions in accordance with this invention are produced using powders that can be blended in one step for a batch process or in a continuous blender. Known compositions require multiple blending steps, which adds to the blending time and cost.

### DETAILED DESCRIPTION OF THE PRESENTLY PREFERRED EMBODIMENTS

As previously discussed, a bipolar separator plate composition for bipolar separator plates employed in polymer electrolyte membrane fuel cell stacks must provide high conductivity and strength while maintaining low corrosion and creep rates. For this purpose, a graphite/binder mixture is used. This mixture must be low in cost, easily blended, quickly moldable, and result in finished products of close dimensional tolerance with a minimal number of post-molding operations. The compositions of this invention generally satisfy all of these requirements.

The compositions comprise graphite powders that can be blended in one step in a batch process or in a continuous blender and that permit the use of molding cycle times of less than about 60 seconds, preferably in the range of about 30 to about 60 seconds. As used herein, molding cycle time includes the time to load the molds with the composition, the time to cure the composition and the time to remove the molded plate. The loading time is reduced through the use of either preforms or a powder loading box. Preforms are low density, partially cured plates, which may be used to produce the end-product bipolar separator plate due to the increased strength derived from the compositions of this invention. Direct powder loading through the use of powder loading boxes is also simplified due to the improved flow properties of the composition of this invention compared to known compositions.

Cure times have been reduced using the compositions of this invention over the cure times for known compositions by at least a factor of 10, from about 10 minutes to less than 1 minute. The keys to lower cure times are higher powder density, better gas release and higher strength. Higher powder density means that less air must be removed to produce a dense plate. Consequently, the need for any bumping or de-gassing steps is eliminated.

In accordance with one embodiment of this invention, the composition utilized to produce the bipolar separator plates of this invention comprises in a range of 1 to 4 different graphite components and at least one resin, with at least one of the graphite components comprising graphite particles having a mean diameter in a range of about 10 microns to about 50 microns. In accordance with one preferred embodiment of this invention, the graphite particles have a mean diameter in the range of about 20 to about 25 microns. The relatively fine particle size of the compositions of this invention allows for gases created as the binder cures to escape faster. And, due to the higher strength associated with the use of these compositions, the amount of resin employed can be reduced compared to the amount employed in known compositions, which, in turn, translates into lesser amounts of curing gases being evolved during the curing process. In addition, also due to the higher strength resulting from the use of these compositions, bipolar separator plates employing the compositions of this invention may be molded thinner, thereby further reducing curing times. And, finally, the enhanced strength of the separator plates employing the compositions of this invention allows for the use of mechanical devices, such as ejector pins, for quick removal of the molded plates from the molds.

Dimensional tolerances of separator plates produced using the compositions of this invention are improved because the finer particle size powders hold form better than the coarser powders of known compositions. In addition, the use of the finer particle size powders enables the powders to be molded into smaller mold features. However, care must be taken to avoid powders that are too fine, because the lower bulk density of the plates produced using such powders will result in an increase in the required cure time. Compositions used to produce separator plates in accordance with this invention provide a good balance between plates having good dimensional tolerances and plates having low cure times.

And, finally, the compositions of this invention permit more flexibility in plate design, including flow field design, and plate property requirements. The plates can be molded over a large range of pressures to control porosity. In addition, plates produced using the compositions of this invention permit the use of numerous additives to modify plate properties, including additives for increasing water transfer and additives for altering surface conductivity.

### EXAMPLE

A single component graphite provided by Superior Graphite of Chicago, Ill. under the name 2926 was used to produce bipolar separator plates for use in polymer electrolyte membrane fuel cell stacks in accordance with this invention. This graphite is a thermally purified graphite having a calculated mean diameter of about 23 microns. A two-stage phenolic resin available from Plastics Engineering Company in Sheboygan, Wis. under the name 12228 was employed as a binder. Several 4-inch by 6.5-inch plates were produced by compression molding with heated platens at 400° F. The plates were cured for 5 minutes to ensure a complete reaction between components of the composition. However, cure times as low as 45 seconds have been employed with satisfactory results. Table 1 shows the properties of separator plates produced using various compositions of graphite and resin.

TABLE 1

| | | Surface | Bulk | Flexural |
|---|---|---|---|---|
| Plate | Density | Resistance | Conductivity | Strength |
| Composition | g/cc | (mΩ) | (S/cm) | (psi) |
| Conventional | 1.93 | 215 | 1100 | 8200 |
| 95% graphite, | 1.94 | 200 | 890 | 8200 |
| 5% resin | | | | |
| 92.5% graphite, | 1.97 | 240 | 880 | 10800 |
| 7.5% resin | | | | |
| 90% graphite, | 1.98 | 280 | 810 | 12100 |
| 10% resin | | | | |
| 85% graphite, | 1.96 | 360 | 590 | 13400 |
| 15% resin | | | | |

As can be seen, plates produced using compositions in accordance with this invention have properties which are comparable to, and in some cases, which constitute substantial improvements over, plates produced using conventional compositions.

While in the foregoing specification this invention has been described in relation to certain preferred embodiments thereof, and many details have been set forth for the purpose of illustration, it will be apparent to those skilled in the art that the invention is susceptible to additional embodiments and that certain of the details described herein can be varied considerably without departing from the basic principles of this invention.

We claim:

1. In a polymer electrolyte membrane fuel cell stack comprising a plurality of fuel cell units comprising an anode electrode, a cathode electrode and a polymer electrolyte membrane disposed between the anode electrode and the cathode electrode, and a bipolar separator plate disposed between the anode electrode of one of the fuel cell units and the cathode electrode of an adjacent fuel cell unit, the improvement comprising:
said bipolar separator plate comprising a composition comprising in a range of 1 to 4 different graphite components and at least one resin, at least one of the graphite components comprising graphite particles having a mean diameter in a range of about 10 microns to about 50 microns.

2. The polymer electrolyte membrane fuel cell stack in accordance with claim 1, wherein the composition comprises one graphite component.

3. The polymer electrolyte membrane fuel cell stack in accordance with claim 1, wherein the graphite particles have a mean diameter of about 23 microns.

4. The polymer electrolyte membrane fuel cell stack in accordance with claim 1, wherein the at least one resin is a two-stage phenolic resin.

5. The polymer electrolyte membrane fuel cell stack in accordance with claim 2, wherein the graphite component comprises in a range of about 85% to about 95% by weight of the bipolar separator plate.

6. The polymer electrolyte membrane fuel cell stack in accordance with claim 1, wherein the bipolar separator plate has a density in a range of about 1.94 to about 1.99 g/cc.

7. A fuel cell stack comprising:
at least one bipolar separator plate comprising a composition comprising in a range of 1 to 4 different graphite components and at least one resin, at least one of the graphite components comprising graphite particles having a mean diameter in a range of about 10 microns to about 50 microns.

8. A fuel cell stack in accordance with claim 7, wherein the composition comprises one graphite component.

9. A fuel cell stack in accordance with claim 7, wherein the graphite particles have a mean diameter of about 23 microns.

10. A fuel cell stack in accordance with claim 7, wherein the at least one resin is a two-stage phenolic resin.

11. A fuel cell stack in accordance with claim 7, wherein the graphite component comprises in a range of about 85% to about 95% by weight of the bipolar separator plate.

12. A fuel cell stack in accordance with claim 7, wherein the bipolar separator plate has a density in a range of about 1.94 to about 1.99 g/cc.

13. A fuel cell stack in accordance with claim 7, wherein the bipolar separator plate has a surface resistance in a range of about 100 mΩ to about 400 mΩ.

14. A fuel cell stack in accordance with claim 7, wherein the bipolar separator plate has a bulk conductivity in a range of about 500 to about 1000 S/cm.

15. A fuel cell stack in accordance with claim 7, wherein the bipolar separator plate has a flexural strength in a range of about 8000 to about 14000 psi.
